(19) United States
(12) Patent Application Publication
(10) Pub. No.: US 2021/0295368 A1
(43) Pub. Date: Sep. 23, 2021

(54) CARD REWARDS TRIGGER AUTOMATIC ONLINE ORDER

(71) Applicant: Capital One Services, LLC, McLean, VA (US)

(72) Inventors: Sam L. TAFFER, McLean, VA (US); Seth Wilton COTTLE, Reston, VA (US); Kathryn TIKOIAN, Arlington, VA (US)

(73) Assignee: Capital One Services, LLC, McLean, VA (US)

(21) Appl. No.: 16/826,860

(22) Filed: Mar. 23, 2020

(51) Int. Cl. G06Q 30/02; G06Q 30/06

(52) U.S. Cl. CPC G06Q 30/0233; G06Q 30/0253; G06Q 30/0635

(57) ABSTRACT

A method for automatic redemption of available reward points is disclosed. The method may include linking a stored data profile of a customer of a merchant with at least one reward account of the customer, and receiving an update corresponding to a changed value of reward points available for redemption. The method may include updating the stored data profile of the customer with the changed value of reward points for redemption, and automatically accessing a list associated with the profile of the customer in response to the updating the stored data profile of the customer. The list may include at least one item to be purchased. The method may include identifying and purchasing at least one item from a subset of items from the list whose redemption values are equal to or less than the changed value of reward points based on a customer preference setting.

### BACKGROUND

Almost all credit card companies reward their customer for the purchase made using a credit card issued by the credit card company. For example, one reward point may be awarded for spending $100 using the credit card. Many customers also have relationships with one or more merchants, with which the customers may have a stored profile containing a wishlist of items to be purchased in the future. However, there is typically little-to-no interaction between the credit card company and the merchant regarding the profile for that customer. Accordingly, coordination between their various accounts is difficult and time consuming for the customer, requiring the customer to navigate multiple online systems.

### BRIEF SUMMARY

Disclosed herein are system, method and/or computer program product embodiments, and/or combinations and sub-combinations thereof, for automatic redemption of available reward points.

In an embodiment, a method is disclosed. The method may include steps such as linking a stored data profile of a customer of a merchant with at least one reward account of the customer and receiving an update corresponding to a changed value of reward points available for redemption. The reward points may be associated with the at least one reward account. The method may further include updating the stored data profile of the customer with the changed value of reward points for redemption in response to the receiving the update and automatically accessing a list associated with the profile of the customer in response to the updating the stored data profile. The list may include at least one item to be purchased. The method may include identifying a subset of items from the list whose redemption values are equal to or less than the changed value of reward points and accessing a customer preference setting associated with the list. The customer preference setting may indicate a redemption preference. The method may also include transmitting a notification to the customer regarding redemption of the available reward points for at least one item in the subset of items, based on the customer preference setting, and in response to an approval indication from the customer, the method may include processing a purchase of the at least one item. The list may include a merchant inventory item that has been automatically selected based on a purchase history of the customer. The customer preference setting may provide a reward point value threshold. The changed value of reward points available for redemption may meet or exceed the reward point value threshold. The merchant inventory item may be the at least one item processed for purchase.

For updating the stored data profile of the customer, the method may include transmitting an application program interface (API) message over a secure network connection. The API message may be one of a hypertext transfer protocol get request message, simple object access protocol (SOAP) web service get request message, and representation state transfer (REST) web service get request message. For identifying a subset of items from the list, the method may include determining a purchase cost for each item in the list, and a number of reward points equivalents to the purchase cost for each item in the list. The method may further include comparing the number of reward points equivalent to the purchase cost for each item in the list with the changed value of reward points available for redemption, and selecting at least one item for which the number of reward points equivalent to the purchase cost is equal to or less than the changed value of reward points, based on the comparison.

The method may further include sending to the customer a notification message regarding the processing of the purchase and a number of reward points redeemed where the approval indication from the customer has previously been received. For sending the notification message to the customer, the method may include sending the notification message in an application program interface (API) message over a secure network connection. The API message may be one of a hypertext transfer protocol post message, simple object access protocol (SOAP) web service post request message, and representation state transfer (REST) web service post request message. The method may also include consolidating reward points from a plurality of reward accounts of the customer to determine the changed value of reward points available for redemption.

In another embodiment, a system is disclosed. The system may include a memory for storing instructions and a processor that is communicatively coupled to the memory. The processor may be configured to execute the instructions that may cause the processor to link a stored data profile of a customer of a merchant with at least one reward account of the customer. The processor may be configured to receive an update corresponding to a changed value of reward points available for redemption. The reward points may be associated with the at least one reward account. The processor may be configured to update the stored data profile of the customer with the changed value of reward points for redemption in response to the receiving, and automatically access a list associated with the profile of the customer in response to the update of the stored data profile of the customer. The list may include at least one item to be purchased. The processor may be configured to identify a subset of items from the list whose redemption values are equal to or less than the changed value of reward points and access a customer preference setting associated with the list. The customer preference setting may indicate a redemption preference. The processor may also be configured to transmit a notification to the customer regarding the redemption of the available reward points for at least one item in the subset of items based on the customer preference setting, and process a purchase of the at least one item in response to an approval indication from the customer. The list may include a merchant inventory item that has been automatically selected based on a purchase history of the customer. The customer preference setting may provide a reward point value threshold. The changed value of reward points available for redemption may meet or exceed the reward point value threshold. The merchant inventory item may be the at least one item processed for purchase.

In order to update the stored data profile of the customer, the processor may be configured to transmit an application program interface (API) message over a secure network connection. The API message may be one of a hypertext transfer protocol (HTTP) get request message, simple object access protocol (SOAP) web service get request message, and representation state transfer (REST) web service get request message. In order to identify a subset of items from the list, the processor may be configured to determine a purchase cost for each item in the list, and a number of reward points equivalent to the purchase cost for each item in the list. The processor may also be configured to compare the number of reward points equivalent to the purchase cost for each item in the list with the changed value of reward points available for redemption and select at least one item for which the number of reward points equivalent to the purchase cost is equal to or less than the changed value of reward points, based on the comparison.

The processor may also be configured to send to the customer a notification message regarding the processing of the purchase and a number of reward points redeemed where the approval indication from the customer has previously been received. In order to send to the customer the notification, the processor may be further configured to send the notification message in an application program interface (API) message over a secure network connection. The API message may be one of a hypertext transfer protocol post message, simple object access protocol (SOAP) web service post request message, and representation state transfer (REST) web service post request message. The processor may also be configured to consolidate reward points from a plurality of reward accounts of the customer to determine the changed value of reward points available for redemption.

In another embodiment, a non-transitory, tangible computer-readable device having instructions stored thereon is disclosed. The instructions when executed by at least one computing device may cause the at least one computing device to perform operations including linking a stored data profile of a customer of a merchant with at least one reward account of the customer and receiving an update corresponding to a changed value of reward points available for redemption. The reward points may be associated with the at least one reward account. The operation may also include updating the stored data profile of the customer with the changed value of reward points for redemption in response to the receiving and automatically accessing a list associated with the profile of the customer in response to the updating the stored data profile of the customer. The list may include at least one item to be purchased. The operations may further include identifying a subset of items from the list whose redemption values are equal to or less than the changed value of reward points and accessing a customer preference setting associated with the list. The customer preference setting may indicate a redemption preference. The operations may include transmitting a notification to the customer regarding redemption of the available reward points for at least one item in the subset of items based on the customer preference setting and processing a purchase of the at least one item in response to an approval indication from the customer.

For updating the stored data profile of the customer, the operations may also include transmitting an application program interface (API) message over a secure network connection. The API message may be one of a hypertext transfer protocol get request message, simple object access protocol (SOAP) web service get request message, and representation state transfer (REST) web service get request message. For identifying a subset of items from the list, the operations may also include determining a purchase cost for each item in the list, and a number of reward points equivalent to the purchase cost for each item in the list. The operations may further include comparing the number of reward points equivalent to the purchase cost for each item in the list with the changed value of reward points available for redemption and selecting at least one item for which the number of reward points equivalent to the purchase cost is equal to or less than the changed value of reward points, based on the comparison.

The operations may also include sending to the customer a notification message regarding the processing of the purchase and a number of reward points redeemed, where the approval indication from the customer has previously been received. For the sending the notification message, the operations may also include sending the notification message in an application program interface (API) message over a secure network connection. The API message may be one of a hypertext transfer protocol post message, simple object access protocol (SOAP) web service post request message, and representation state transfer (REST) web service post request message. The operations may also include consolidating reward points from a plurality of reward accounts of the customer to determine the changed value of reward points available for redemption.

### BRIEF DESCRIPTION OF THE DRAWINGS/FIGURES

FIG. 1 illustrates an example network diagram, in accordance with some embodiments.

FIG. 2 illustrates a flow chart of steps, in accordance with some embodiments.

FIG. 3 illustrates an example notification message, in accordance with some embodiments.

FIG. 4 illustrates an example server platform, in accordance with some embodiments.

FIG. 5 illustrates an example user profile record, in accordance with some embodiments.

FIG. 6 illustrates an example computer system, in accordance with some embodiments.

### DETAILED DESCRIPTION

Provided herein are a method, a system, and a computer program product embodiments, and/or combinations and sub-combinations thereof, for triggering an automatic online order of one or more items using available reward points. Accordingly, if there are sufficient reward points accumulated in a reward program account of a user, a notification of an offer to redeem available reward points towards a purchase of an item from a wishlist may be sent to the user. The wishlist may be created by the user on a web site of a merchant or a vendor. The user may either accept the offer to redeem the available reward points towards an item in the wishlist or may request the redemption of the available reward points towards a purchase of another item. The user may decline to redeem the available reward points as well.

The Summary and Abstract sections may set forth one or more but not all examples of embodiments of the present invention as contemplated by the inventor(s), and thus, are not intended to limit the present invention and the appended claims in any way.

A user may be awarded one or more reward points as part of a customer loyalty program, such as one reward point for each dollar spent using a particular credit card. Accumulated reward points above a specific threshold may be available for redemption. For example, the financial institution may set the specific threshold to be 5000 reward points. Accordingly, if a user has accumulated at least 5000 reward points in his or her reward program account, then the user may request redemption of the available reward points. Where the loyalty program is associated with a particular credit card, for example, the reward point value awarded for a given financial transaction completed using the card may be dependent on the purchase category associated with the financial transaction. For example, two reward points may be awarded for each dollar spent on a purchase of gas or grocery, but five reward points may be awarded for each dollar spent on travel-related purchases such as hotel booking or a ticket purchase for travel by air, train, and/or bus.

The user may redeem the accumulated reward points in different ways. For example, the user may request a deposit of cash balance for the redemption of the reward points. The financial institution may offer an option to purchase gift cards using the available reward points. The user may apply reward points towards previously completed transactions in one or more billing statements. In some cases, the user may redeem available reward points towards a merchandise purchase. The merchandise available for purchase may be limited to very few categories, such as electronics, home, travel, and accessories, etc. The user may not be interested in purchasing the merchandise available at the financial institution's online web site. In addition, in some cases, if the reward points are not redeemed within a certain time period, the user may forfeit the reward points. In general, for the financial institution, the large number of unredeemed reward points may create a huge liability.

An objective of the present application is, therefore, to automate purchase of an item from a merchant using the reward points. In accordance with some embodiments, the financial institution and a merchant may collaborate with each other, and thereby the merchant may offer an option for a user of its website to link the user's merchant account with a reward program account at the financial institution. The user may create a profile (also referred to herein as an account) with the merchant's website, as the user may be a frequent customer of the merchant. The user who has created the profile with the merchant's website may be referred to as a registered user in this disclosure. The merchant may provide an option to the registered user of linking the user profile associated with the merchant to a reward program account at at least one financial institution. An option for registering and linking the reward program account with the profile at the merchant's website may be prenegotiated between the merchant and the financial institution. Accordingly, when the user provides details of the reward program account while creating the profile at the merchant's website, one or more servers managing the profile at the merchant may exchange one or more messages with the one or more servers managing the reward program account at the financial institution. The financial institution may be, for example, a bank or a company offering a credit card or a credit line.

In some embodiments, one or more messages between the one or more servers at the merchant and the one or more servers at the financial institution may be communicated over a communication network. The communication network may include the Internet, a radio access network communication using Wi-Fi, 2G, 3G, 4G, 5G, etc., a wireline communication system, a wireless communication system, a satellite communication system, etc. The communication network may allow transmission of a message over a secure network connection using IPSec, SSH, virtual private networking (VPN), secured TCP/IP or UDP/IP protocol, etc. The communication network may use hypertext transfer protocol secure (HTTPS) for securely communicating between the one or more servers at the merchant and the one or more servers at the financial institution. The message exchanged between the one or more servers at the merchant and the one or more servers at the financial institution may be an application program interface (API) message. The API message may use a web service according to hypertext transfer protocol (HTTP) or hypertext transfer protocol secure (HTTPS), simple object access protocol (SOAP), and/or representation state transfer (REST).

In some embodiments, a merchant server may send a message to a financial institution server when the user provides reward account program details to the merchant while creating or updating the profile at the merchant's website. The message may include details provided by the user of the reward program account. The message may also include configuration information such as how often the financial institution may update the profile with the number or value of reward points available for redemption. The message may also include information allowing the financial institution to access all or limited details of the profile or the account at the merchant. By way of a non-limiting example, the user may also create a wishlist on an online store of the financial institution where the user may purchase an item using the credit or debit card issued by the financial institution or using reward points available for redemption. Accordingly, the financial institution may have access to or query the merchant for items in a wishlist associated with the user profile at the merchant. The user may create a wishlist and may add items available at the merchant for later purchase or purchase on a special occasion such as a birthday, an anniversary, etc. The user may also add an item to the wishlist because the item is expensive, and the user may not have a budget to purchase the item. If the user provides reward account program details to the merchant, then the merchant and the financial institution both have access to the available reward points and items in the wishlist. Accordingly, whenever the user logs in to the profile, the profile may be updated to display available reward points for redemption. The profile may also be automatically updated when there is a change in the value of the reward points available for redemption. The change in the value of the reward points available for redemption may occur when the user purchases items using a credit card associated with the reward account.

In some embodiments, the user may download a mobile application associated with the merchant. The mobile application may be downloadable from one or more application stores for shopping with the merchant. The mobile application may be available for different devices, including a mobile phone, a smartphone, a tablet, a computer, etc. The user may create a new profile using the downloaded mobile application. The user may also update the created profile or an existing profile using the downloaded mobile application, to link the profile or the account with the reward program account of the financial institution as described above. Accordingly, once the user provides details of the reward program account to link or pair the profile at the merchant with the financial institution rewards program account, the one or more servers at the financial institution and the one or more servers at the merchant may exchange API messages to update the reward points available for immediate redemption and the items in the wishlist created by the user.

In accordance with some embodiments, the one or more servers at the merchant may provide a current price of the items in the wishlist to the one or more servers at the financial institution. Based on the price for each item in the wishlist and the reward points available for immediate redemption, the one or more servers at the financial institution may determine if any item from the wishlist of the user is available for immediate purchase. If the one or more servers at the financial institution determine that an item in the wishlist is available for purchase using the reward points, the one or more servers at the financial institution may access a customer preference setting associated with the wishlist. The customer preference setting may indicate a redemption preference, for example, whether a purchase should be made immediately when enough points are available, whether prior approval from the customer is required before purchasing an item in the wishlist, etc. If the customer preference setting indicates that a prior approval from the customer is required, the one or more servers at the financial institution may transmit a notification to the user. The notification may be a push notification to the mobile application or a pull notification by the mobile application. The notification may be an email to an email address on record with the financial institution and/or the merchant. The notification may also be displayed to the user when the user logs in to the merchant's website and/or when the user logs in to the financial institution's website.

In some embodiments, when the customer preference setting indicates the purchase should be made immediately, i.e., without prior approval from the user, when enough points are available, a notification to the user may be related to the reward points redeemed towards the purchase of the at least one item in the subset of items. The notification may also include remaining reward points available for redemption and/or cash equivalent of the remaining rewards points available for redemption. The notification may list specific items from the wishlist and include an option for the user to select one or more items from the wishlist. The notification may include an option not to purchase an item using the reward points. The notification may include an option for selecting an item on behalf of the user, where the item may be selected based on a purchase history of the user. The notification may be a push notification to the mobile application or a pull notification by the mobile application. The notification may be an email to an email address on record with the financial institution and/or the merchant. The notification may also be displayed to the user when the user logs in to the merchant's website and/or when the user logs in to the financial institution's website. The notification message may be an application programming interface (API) message over a secure network connection. The API message may be one of a hypertext transfer protocol post message, simple object access protocol (SOAP) web service post request message, and representation state transfer (REST) web service post request message.

In some embodiments, regardless of the customer preference setting, as described above, a notification may be sent to the user upon redeeming reward points towards the purchase of the at least one item in the subset of items.

In accordance with some embodiments, for the option of selecting an item on behalf of the user, the one or more servers at the merchant may transmit a list of all items previously purchased by the user at the merchant. The merchant may send details of items purchased by the user only when the purchase is made using a credit card issued and/or managed by the financial institution. The merchant or the financial institution may also allow an option on their website and/or the mobile application to upload an image of a receipt that lists all purchased items. Alternatively, the user may also provide details of the purchased items by manually adding details on the website or the mobile application of the merchant or the website of the financial institution. The user's purchase history may also have already been generated by and stored at the financial institution based on previous transactions made by the user with the associated credit card. The one or more servers at the financial institution may analyze the purchase history of the user for purposes such as identifying the periodic pattern of each item purchased by the user, making a recommendation of items to other customers, etc.

In accordance with some embodiments, when the user selects an option or provides an approval to redeem the reward points for one or more items from the wishlist, the item is purchased. Purchasing the item using rewards points may involve the financial institution converting the requisite number of rewards points to their cash value, and transmitting funds equal to that cash value to the merchant. Alternatively, purchasing the item using rewards points may involve converting the requisite number of rewards points to their cash value, and transferring funds equal to that cash value from the user's credit account to the merchant, followed by an immediate credit to the user's credit account by the financial institution of funds equal to the cash value. An API message may be sent from the one or more servers at the merchant to the one or more servers at the financial institution to update the reward program account for the reward points redeemed and/or to transfer a cash equivalent of the redeemed reward points to the merchant. In accordance with some embodiments, an option of applying reward points available for immediate redemption as payment toward current checkout items in the user's online cart at the merchant may be available.

In accordance with some embodiments, the customer preference setting corresponding to the merchant profile may provide an option to purchase one or more items from the wishlist automatically if the one or more items from the wishlist are available for immediate purchase by redeeming the reward points. The customer preference setting may also include a threshold for reward points value that indicates a maximum number of available reward points at which an item in the wishlist may be assessed for immediate purchase using the available reward points for redemption. If the user has selected the option to purchase one or more items from the wishlist by automatically redeeming the available reward points, the one or more items may be purchased and shipped to the user as a surprise. A notification message may list the one or more items that were automatically purchased and the number of reward points redeemed. The wishlist may also be updated to remove the purchased one or more items from the wishlist.

In accordance with some embodiments, if the user has more than one reward program account at the financial institution, reward points available in those accounts may be consolidated to increase buying power. In this way, a more expensive item from the wishlist may be purchased that could not be purchased using reward points available at any single reward program account. In yet another embodiment, the reward points available to the user for redemption may include reward points earned from purchases by an authorized user of the card. The authorized user of the card may be, for example, a family member of the primary cardholder.

Various embodiments of these features will now be discussed with respect to the corresponding figures.

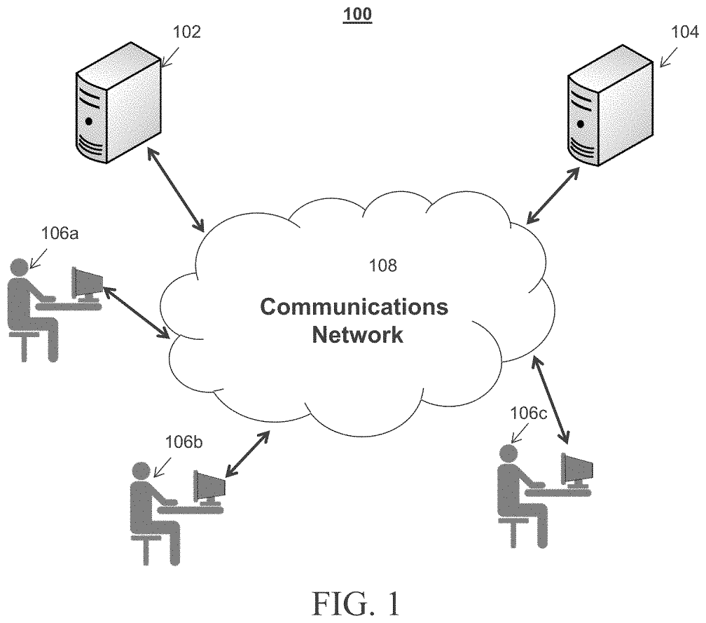

FIG. 1 illustrates an example network diagram in accordance with some embodiments. As shown in FIG. 1, a network 100 may include a first server 102, a second server 104, and users 106a, 106b, and 106c communicating over a communications network 108. The first server 102 may be a server at a merchant and the second server 104 may be a server at a financial institution. Though only one server is displayed at each of the merchant and the financial institution, there may be more than one server at each of the merchant and the financial institution. The server 102 and/or the server 104 may be an application server. The server 102 and/or the server 104 may act as a backend system for a web application or a mobile application. The server 102 and the server 104 may also include a database and may be a database server. While only three users 106a, 106b, and 106c are shown in FIG. 1 for purposes of explanation, an actual number of users may be many thousands more. In the following disclosure, the embodiments may be discussed using the user 106a but may also apply to other users 106b and/or 106c.

In accordance with some embodiments, the server 102 at the merchant may send a message to the server 104 at the financial institution when one or more users 106a, 106b, and/or 106c provide reward account program details to the merchant while creating or updating a profile at the merchant's website. The server 102 may act as a web server for the merchant's website. The message from the server 102 may include details provided by the user 106a of the reward program account. The message from the server 102 may also include configuration information such as how often the financial institution may update the profile or the account for the available reward points for redemption. The message may also include information of the profile or the account at the merchant for the merchant to access all or limited details of the profile or the account at the merchant. Accordingly, the server 104 at the financial institution may have access to or query the server 102 at the merchant for items in a wishlist at the profile or the account of the user 106a at the merchant. The user 106a may create a wishlist and may insert one or more items available at the merchant for later purchase or for purchase on a special occasion such as a birthday, an anniversary, etc. The user 106a may also insert an item in the wishlist because the item is expensive, and the user 106a may not have current funds to purchase the item. However, if the user 106a has provided reward account program details to the merchant, the merchant and the financial institution both have access to the available reward points and items in the wishlist. Accordingly, whenever the user 106a logs in to the profile, the profile may be updated to display available reward points for redemption. The profile of the customer or the account may also be updated when there is a change in the value of the reward points available for redemption. The change in the value of the reward points available for redemption may occur as the user 106a purchases items using a credit card associated with the reward account.

In accordance with some embodiments, the user 106a may download a mobile application. The mobile application may be downloadable from one or more application stores for shopping with the merchant. The mobile application may be available for different devices, including a mobile phone, a smartphone, a tablet, a computer, etc. The user 106a may create a new profile or a new account using the downloaded mobile application. The user 106a may also update the created profile or account using the downloaded mobile application to link the profile or the account with the reward program account of the financial institution as described above. Accordingly, once the user 106a has provided details of the reward program account to link or pair the profile or the account at the merchant with the financial institution, the server 104 at the financial institution and the server 102 at the merchant may exchange the application program interface (API) message to update the reward points available for immediate redemption and the items in the wishlist created by the user 106a.

In accordance with some embodiments, the server 102 at the merchant may provide a current price of the items in the wishlist of the profile or the account of the user 106a to the server 104 at the financial institution. Based on the price for each item in the wishlist and the reward points available for immediate redemption, the server 104 at the financial institution or the server 102 at the merchant may determine if any item from the wishlist of the user 106a is available for immediate purchase. If the server 104 or the server 102 determines that an item in the wishlist is available for purchase using the reward points, the server 104 or the server 102 may check the customer preference setting for redemption preference. For example, the redemption preference may indicate whether a purchase should be made immediately when enough points are available, whether prior approval from the customer is required before purchasing an item in the wishlist, etc. If the customer preference setting indicates that a prior approval from the user 106a is required, the server 104 or the server 102 may transmit a notification to the user 106a. The notification may be a push notification to the mobile application on a mobile device of the user 106a or a pull notification by the mobile application on the mobile device of the user 106a. The notification may be an email to an email address of the user 106a on record with the financial institution and/or the merchant. The notification may also be displayed to the user 106a when the user logs in to the merchant's website or when the user logs in to the financial institution's website.

In accordance with some embodiments, when the customer preference setting indicates the purchase should be made immediately, i.e., without prior approval from the user 106a, when enough points are available, a notification to the user 106a may be related to the reward points redeemed towards the purchase of the at least one item in the subset of items. The notification may also include remaining reward points available for redemption and/or cash equivalent of the remaining rewards points available for redemption. The notification may list specific items from the wishlist and include an option for the user to select one or more items from the wishlist. The notification may include an option not to purchase an item using the reward points. The notification may include an option for selecting an item on behalf of the user, where the item may be selected based on a purchase history of the user. The notification may be a push notification to the mobile application or a pull notification by the mobile application. The notification may be an email to an email address on record with the financial institution and/or the merchant. The notification may also be displayed to the user when the user logs in to the merchant's website and/or when the user logs in to the financial institution's website. The notification message may be an application programming interface (API) message over a secure network connection. The API message may be one of a hypertext transfer protocol post message, simple object access protocol (SOAP) web service post request message, and representation state transfer (REST) web service post request message.

In accordance with some embodiments, regardless of the customer preference setting, as described above, a notification may be sent to the user 106a upon redeeming reward points towards the purchase of the at least one item in the subset of items.

In accordance with some embodiments, one or more messages between the server 102 at the merchant and the server 104 at the financial institution may be communicated over the communication network 108. The communication network 108 may include the Internet, a radio access network communication using Wi-Fi, 2G, 3G, 4G, 5G, etc., a wireline communication system, a wireless communication system, a satellite communication system, etc. The communication network 108 may allow transmission of a message over a secure network connection using IPsec, SSH, virtual private networking (VPN), secured TCP/IP or UDP/IP protocol, etc. The communication network 108 may use hypertext transfer protocol secure (HTTPS) for securely communicating between the server 102 at the merchant and the server 104 at the financial institution. The message(s) exchanged between the server 102 at the merchant and the server 104 at the financial institution may be an API message. The API message may use a web service according to hypertext transfer protocol (HTTP) or a hypertext transfer protocol secure (HTTPS), simple object access protocol (SOAP), and/or representation state transfer (REST). The communication from the user 106a, i.e., from the mobile application downloaded on a mobile device of the user 106a or from a web browser of a computer of the user 106a, to the server 102 and/or the server 104 may also use a secure communication protocol.

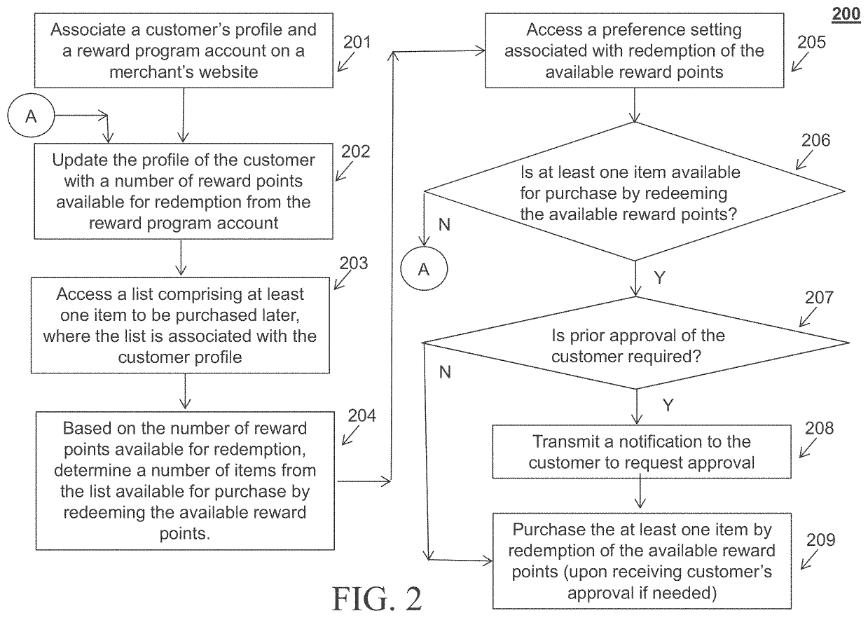

FIG. 2 illustrates a flow chart of steps, in accordance with some embodiments. At step 201, a profile of the user 106a at the merchant and a reward program account at the financial institution are linked or associated with each other on the merchant's website. As described above, the user 106a may create a profile at the merchant's website by visiting the merchant's website from a web browser of a computer or a mobile device of the user 106a. The mobile device of the user 106a may be a mobile phone, a smartphone, a tablet, a laptop, etc. The user 106a may also download a mobile application on the computer or the mobile device to create the profile or the account with the merchant. The user 106a may provide details of the reward account program while creating the profile with the merchant. The user 106a may also update a previously created profile or account to provide details of the reward account program. The information provided by the user 106a via the web browser or the mobile application may be stored at the server 102 in one or more database records.

In accordance with some embodiments, at step 202, after the user 106a has provided details of the reward program account to be linked to or associated with the merchant profile, the server 102 at the merchant may send a message to the server 104 at the financial institution to receive details of currently available reward points for redemption by the user 106a. The message from the server 102 to the server 104 may include details of the reward account of the user 106a at the financial institution. The message may also include details or information of the profile at the merchant. The message may be an API message as described above and may be sent over the communication network 108. Upon receiving the API message at the server 104, the server 104 at the financial institution may also save or update one or more database records of the reward program account with the information received from the server 102 in the API message. The server 104 may build and send a message that provides currently available reward points for redemption by the user 106a to the server 102 in response to the message from the server 102 querying currently available reward points for redemption by the user 106a. Since the server 104 manages one or more reward programs at the financial institution, the server 104 may also act as a reward program application server. The server 104 may then periodically, or whenever there is a change in the available reward points, send an update to the server 102 regarding the number of reward points available for immediate redemption.

In accordance with some embodiments, at step 203, the server 102 and/or the server 104 may access the wishlist associated with the profile of the user 106a. The wishlist may include at least one item to be purchased later. As described above, the server 102 and the server 104 may exchange a list of items in a wishlist created by the user 106a at the merchant, a purchase price of each item in the wishlist, details of purchases made by the user 106a at the merchant either online or in-store, etc., using the API message(s). Therefore, the server 102 at the merchant and the server 104 at the financial institution both have information regarding the reward points available for immediate redemption, items in the wishlist of the user, and the purchase history of the user.

In accordance with some embodiments, at step 204, the server 102 and/or the server 104 may determine if one or more items in the wishlist of the user 106a are available for purchase by redeeming the reward points. Since both the server 102 and the server 104 have information regarding one or more items in the wishlist of the user 106a, including the purchase price, the server 102 and/or the server 104 may determine if the reward points may be applied to purchase the one or more items in the user's wishlist. For example, if the user has added a smart television set to the wishlist, which costs 800 dollars, then 80000 reward points may be required for that point value to purchase the smart television set by redeeming the reward points. For example, if the reward points available for immediate redemption are 80002, the server 102 and/or the server 104 may determine that the user 106a may immediately purchase the smart television set in the wishlist by redeeming the reward points.

In accordance with some embodiments, at step 205, the server 102 and/or the server 104 may access a customer preference setting associated with the redemption of the available reward points. The customer preference setting may indicate whether a prior approval from the customer is required or not before purchasing an item from the wishlist by redeeming the available reward points. The customer preference setting may also indicate a maximum threshold of available reward points for purchasing an item from the wishlist using the available reward points. The customer preference setting may also indicate whether any items may be purchased automatically based on the user's purchase history, when the available reward points exceed a maximum threshold of available reward points, no wishlist exists, or no item from the wishlist is available for purchase using the available reward points.

In accordance with some embodiments, at step 206, the server 102 and/or the server 104 may determine that at least one item is available for purchase by redeeming the available reward points. The server 102 and/or the server 104 may compare the reward points required for each item in the wishlist based on the price for each item in the wishlist and conversion from price to the number of reward points. If it is determined that no item from the wishlist is available for purchase using the reward points, the method may return to step 202 and continue from there again when there is another update to the number of reward points available for redemption. If at least one item from the wishlist is available, the method proceeds to step 207.

In accordance with some embodiments, at step 207, the server 102 and/or the server 104 may determine whether prior approval from the customer is required before purchasing an item from the wishlist by redeeming the available reward points. If prior approval from the customer is not required, then the method proceeds to step 209. If a prior approval from the customer is required, then the server 102 and/or the server 104 may send a notification message to the user 106a to request approval from the user 106a at step 208. The notification may be a push notification to the mobile application downloaded at the mobile device of the user 106a or a pull notification by the mobile application downloaded at the mobile device of the user 106a. The notification message may be an email to an email address of the user 106a on record with the financial institution and/or the merchant. The notification message may also be displayed to the user when the user logs in to the merchant's website and/or when the user logs in to the financial institution's website.

The notification message to the user 106a may include a number of reward points available for redemption and/or a cash equivalent of the rewards points available for redemption. The notification message may include one or more items available for purchase by redeeming the available reward points. The notification message may include an option for the user 106a to select one or more items from the wishlist. The notification message may include an option not to purchase an item using the reward points. The notification message may include an option of selecting an item on behalf of the user 106a, where the item may be selected by the server 102 and/or the server 104 based on a purchase history of the user 106a.

In accordance with some embodiments, for the option of selecting an item on behalf of the user 106a, the server 102 at the merchant may transmit a list of all items previously purchased by the user 106a at the merchant. The merchant may send details of items purchased by the user 106a only when the purchase is made using a credit card issued and/or managed by the financial institution. The merchant or the financial institution may also allow an option on their website and/or the mobile application to upload an image of a receipt that lists all purchased items by the user 106a. Alternatively, the user 106a may provide details of the purchased items by manually adding details on the website or the mobile application of the merchant or the website of the financial institution. The user's purchase history may also have already been generated by and stored at the financial institution based on previous transactions made by the user 106a with the associated credit card. The server 104 at the financial institution and/or the server 102 at the merchant may analyze the purchase history of the user for purposes such as identifying the periodic pattern of each item purchased by the user, making a recommendation of items to other customers, etc.

In accordance with some embodiments, at step 209, if the user 106a has provided an approval to purchase the at least one item available for purchase by redemption of the available reward points, the server 102 and/or the server 104 may purchase the at least one item from the wishlist by immediately redeeming the available reward points. Alternatively, if the user 106a chose to purchase one or more items that are not in the wishlist created by the user 106a, but recommended by the server 102 and/or the server 104 based on the purchase history of the user 106a, reward points may be applied towards the purchase of the one or more recommended items. The user 106a may also apply the reward points towards payment for the current purchase being made by the user 106a instead of redeeming the available reward points towards the purchase of an item from the wishlist or an item suggested for purchase based on the purchase history of the user 106a. The server 102 and the server 104 may communicate using the API message to update the remaining balance of reward points based on the purchase at step 209 and to transfer the cash equivalent of the redeemed reward points.

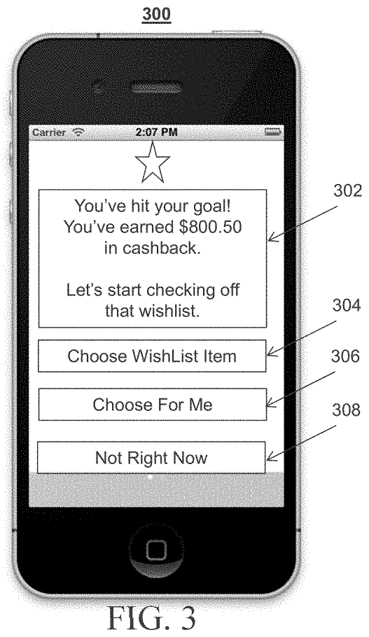

FIG. 3 illustrates an example of a notification message 300, in accordance with some embodiments. As shown in FIG. 3, a notification message 300 sent to the mobile application downloaded on the mobile device of the user 106a is displayed. The server 102 and/or the server 104 determined that the user 106a has reward points for immediate redemption that may be applied towards the purchase of one or more items in the wishlist of the user 106a. In this example, the user 106 has 80050 reward points, which translates to a cash amount of, for example, 800.50 dollars. As described, the user 106a has added a smart television set to the wishlist, which currently costs 800 dollars. The user 106a may, therefore, purchase the smart television set using the reward points. Accordingly, the notification message 300 may indicate to the user 106a that “You have hit your goal! You've earned $800.50 in cashback. Let's start checking off that wishlist” 302 as shown in FIG. 3. The notification message 300 may include a clickable link 304 that allows the user 106 to select one or more items from the wishlist that the user 106a created earlier. The user may select one or more items from the wishlist and may apply the reward points towards the purchase of the one or more items from the wishlist. The notification message 300 may include a clickable link 306 that allows the user 106a to select one or more items recommended by the server 102 and/or the server 104. The one or more items recommended by the server 102 and/or the server 104 may be selected based on the purchase history of the user 106a. The notification message 300 may also include a clickable link 308 that allows the user 106a to exercise an option not to redeem the available reward points.

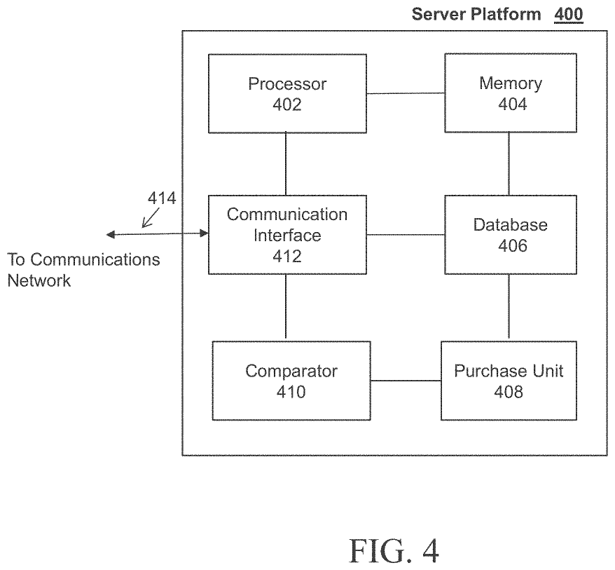

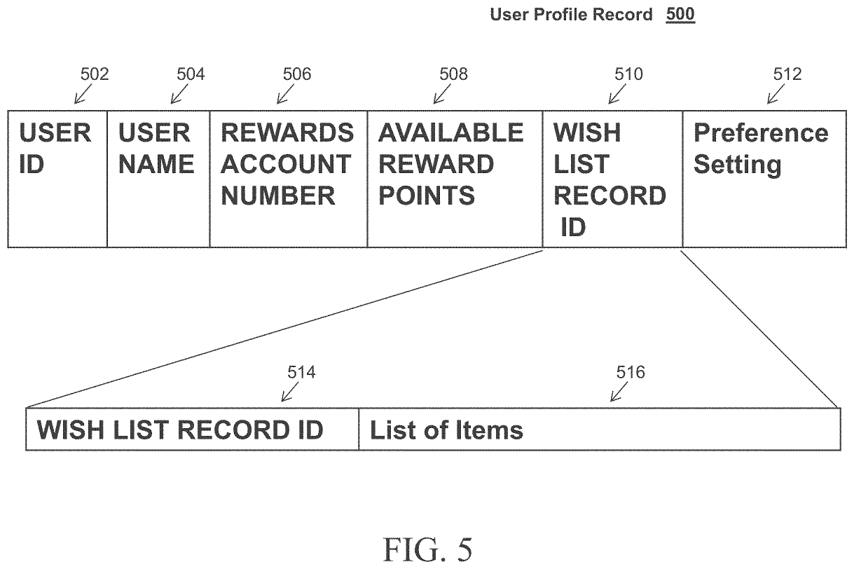

FIG. 4 illustrates an example server platform 400, in accordance with some embodiments. The server platform 400, as shown in FIG. 4, may include a processor 402, a memory 404, a database 406, a purchase unit 408, a comparator 410, and a communication interface 412 that connects the server 400 to a communication network 108 over a communication link 414. The processor 402 may execute instructions stored in the memory 404 to perform method steps as described herein. The database 406 may store a customer profile record. An example of a customer profile record or a user profile record is shown in FIG. 5 and discussed in detail below. The customer profile record may be communicated over the communication network 108 using the communication link 414. The communication link may be an HTTP/HTTPS link. The comparator 410 may access a wishlist and determine reward points required for the purchase of an item from the wishlist as described herein. And, when at least one item is determined as available for immediate purchase by the redemption of the available reward points, the purchase unit 408 may purchase the at least one item as described above.

FIG. 5 illustrates an example of a user profile record 500, in accordance with some embodiments. The user profile record 500 may include, for example, and without limitation, the following fields: a user ID 502, a user name 504, a rewards account number 506, a number of available reward points, a wishlist record ID 510, and a customer preference setting 512. The customer preference setting 512 may describe user preferences regarding the redemption of the available reward points 508. The reward account number 506 may be provided by the user 106a to the merchant server 104 to link the profile at the merchant's website with the financial institution. The wishlist record ID 510 may point to another database indexed based on the wishlist record ID 514 and may include a list of items 516 that the user 106a may have added to the wishlist for a later purchase.

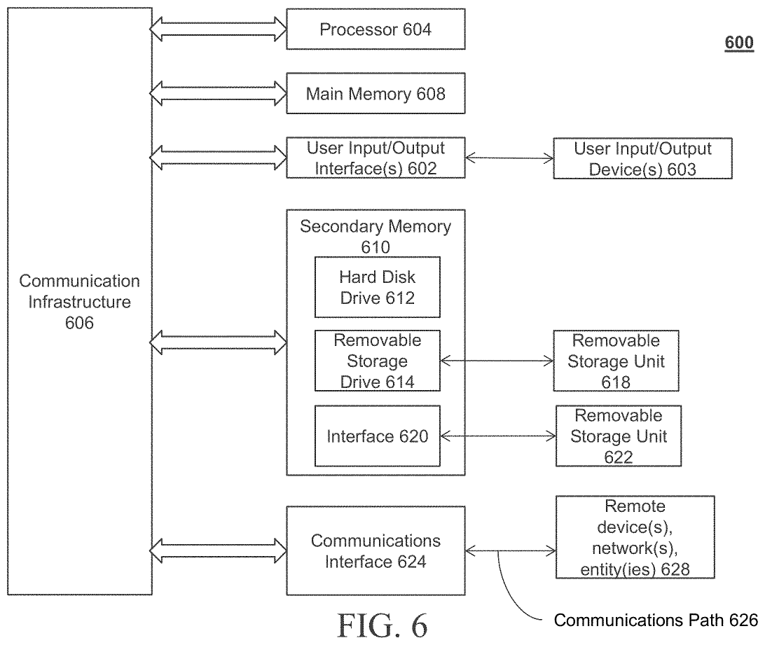

FIG. 6 illustrates an example of a computer system, in accordance with some embodiments.

Various embodiments may be implemented, for example, using one or more well-known computer systems, such as a computer system 600, as shown in FIG. 6. One or more computer systems 600 may be used, for example, to implement any of the embodiments discussed herein, as well as combinations and sub-combinations thereof. The computer systems 600 may be used, for example, for the server 102 and/or the server 104 described above.

The computer system 600 may include one or more processors (also called central processing units, or CPUs), such as a processor 604. The processor 604 may be connected to a communication infrastructure or bus 606.

The computer system 600 may also include user input/output device(s) 603, such as monitors, keyboards, pointing devices, etc., which may communicate with communication infrastructure 406 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 600 may also include a main or primary memory 608, such as random access memory (RAM). Main memory 608 may include one or more levels of cache. Main memory 608 may have stored therein control logic (i.e., computer software) and/or data.

The computer system 600 may also include one or more secondary storage devices or memory 610. The secondary memory 610 may include, for example, a hard disk drive 612 and/or a removable storage device or drive 614. The removable storage drive 614 may be a floppy disk drive, a magnetic tape drive, a compact disk drive, an optical storage device, tape backup device, and/or any other storage device/drive.

The removable storage drive 614 may interact with a removable storage unit 618. The removable storage unit 618 may include a computer usable or readable storage device having stored thereon computer software (control logic) and/or data. The removable storage unit 618 may be a floppy disk, magnetic tape, compact disk, DVD, optical storage disk, and/any other computer data storage device. The removable storage drive 614 may read from and/or write to the removable storage unit 618.

The secondary memory 610 may include other means, devices, components, instrumentalities or other approaches for allowing computer programs and/or other instructions and/or data to be accessed by the computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 600 may further include a communication or network interface 624. The communication interface 624 may enable the computer system 600 to communicate and interact with any combination of external devices, external networks, external entities, etc. (individually and collectively referenced by reference number 628). For example, the communication interface 624 may allow the computer system 600 to communicate with the external or remote devices 628 over communications path 626, which may be wired and/or wireless (or a combination thereof), and which may include any combination of LANs, WANs, the Internet, etc. Control logic and/or data may be transmitted to and from the computer system 400 via the communication path 626.

The computer system 600 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof

The computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture including a tangible, non-transitory computer useable or readable medium having control logic (software) stored thereon may also be referred to herein as a computer program product or program storage device. This includes, but is not limited to, the computer system 600, the main memory 608, the secondary memory 610, and the removable storage units 618 and 622, as well as tangible articles of manufacture embodying any combination of the foregoing. Such control logic, when executed by one or more data processing devices (such as the computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described examples of embodiments, but should be defined only in accordance with the following claims and their equivalents.

What is claimed is:

1. A method for automatic redemption of available reward points, comprising:
linking a stored data profile of a customer of a merchant with at least one reward account of the customer;
receiving an update corresponding to a changed value of reward points available for redemption, the reward points associated with the at least one reward account;
updating the stored data profile of the customer with the changed value of reward points for redemption in response to the receiving;
in response to the updating, automatically accessing a list associated with the profile of the customer, wherein the list comprises at least one item to be purchased;
identifying a subset of items from the list whose redemption values are equal to or less than the changed value of reward points;
accessing a customer preference setting associated with the list, the customer preference setting indicating a redemption preference;
based on the customer preference setting, transmitting a notification to the customer regarding redemption of the available reward points for at least one item in the subset of items; and
in response to an approval indication from the customer, processing a purchase of the at least one item.

2. The method of claim 1, wherein updating the stored data profile of the customer comprises:
transmitting an application program interface (API) message over a secure network connection,
wherein the API message is one of a hypertext transfer protocol get request message, simple object access protocol (SOAP) web service get request message, and representation state transfer (REST) web service get request message.

3. The method of claim 1, wherein identifying a subset of items from the list comprises:
determining a purchase cost for each item in the list;
determining a number of reward points equivalent to the purchase cost for each item in the list;
comparing the number of reward points equivalent to the purchase cost for each item in the list with the changed value of reward points available for redemption; and
based on the comparison, selecting at least one item for which the number of reward points equivalent to the purchase cost is equal to or less than the changed value of reward points.

4. The method of claim 1, wherein the approval indication from the customer has previously been received, the method further comprising:
sending to the customer a notification message regarding the processing of the purchase and a number of reward points redeemed.

5. The method of claim 4, wherein the sending comprises:
sending the notification message in an application program interface (API) message over a secure network connection,
wherein the API message is one of a hypertext transfer protocol post message, simple object access protocol (SOAP) web service post request message, and representation state transfer (REST) web service post request message.

6. The method of claim 1, further comprising:
consolidating reward points from a plurality of reward accounts of the customer to determine the changed value of reward points available for redemption.

7. The method of claim 1, wherein
the list includes a merchant inventory item that has been automatically selected based on a purchase history of the customer,
the customer preference setting provides a reward point value threshold,
the changed value of reward points available for redemption meets or exceeds the reward point value threshold, and
the merchant inventory item is the at least one item processed for purchase.

8. A system, comprising:
a memory for storing instructions; and
a processor, communicatively coupled to the memory, configured to execute the instructions, the instructions when executed causing the processor to:
link a stored data profile of a customer of a merchant with at least one reward account of the customer;
receive an update corresponding to a changed value of reward points available for redemption, the reward points associated with the at least one reward account;
update the stored data profile of the customer with the changed value of reward points for redemption in response to the receiving;
in response to the update, automatically access a list associated with the profile of the customer, wherein the list comprises at least one item to be purchased;
identify a subset of items from the list whose redemption values are equal to or less than the changed value of reward points;
access a customer preference setting associated with the list, the customer preference setting indicating a redemption preference;
based on the customer preference setting, transmit a notification to the customer regarding redemption of the available reward points for at least one item in the subset of items; and
in response to an approval indication from the customer, process a purchase of the at least one item.

9. The system of claim 8, wherein to update the stored data profile of the customer, the instructions further cause the processor to:
transmit an application program interface (API) message over a secure network connection,
wherein the API message is one of a hypertext transfer protocol get request message, simple object access protocol (SOAP) web service get request message, and representation state transfer (REST) web service get request message.

10. The system of claim 8, wherein to identify a subset of items from the list, the instructions further cause the processor to:
determine a purchase cost for each item in the list;
determine a number of reward points equivalent to the purchase cost for each item in the list;
compare the number of reward points equivalent to the purchase cost for each item in the list with the changed value of reward points available for redemption; and
based on the comparison, select at least one item for which the number of reward points equivalent to the purchase cost is equal to or less than the changed value of reward points.

11. The system of claim 8, wherein when the approval indication from the customer has previously been received, the instructions further cause the processor to:
send to the customer a notification message regarding the processing of the purchase and a number of reward points redeemed.

12. The system of claim 11, wherein to send to the customer the notification, the instructions further cause the processor to:
send the notification message in an application program interface (API) message over a secure network connection,
wherein the API message is one of a hypertext transfer protocol post message, simple object access protocol (SOAP) web service post request message, and representation state transfer (REST) web service post request message.

13. The system of claim 8, wherein the instructions further cause the processor to consolidate reward points from a plurality of reward accounts of the customer to determine the changed value of reward points available for redemption.

14. The system of claim 8, wherein
the list includes a merchant inventory item that has been automatically selected based on a purchase history of the customer,
the customer preference setting provides a reward point value threshold,
the changed value of reward points available for redemption meets or exceeds the reward point value threshold, and
the merchant inventory item is the at least one item processed for purchase.

15. A non-transitory, tangible computer-readable device having instructions stored thereon that, when executed by at least one computing device, cause the at least one computing device to perform operations comprising:
linking a stored data profile of a customer of a merchant with at least one reward account of the customer;
receiving an update corresponding to a changed value of reward points available for redemption, the reward points associated with the at least one reward account;
updating the stored data profile of the customer with the changed value of reward points for redemption in response to the receiving;
in response to the updating, automatically accessing a list associated with the profile of the customer, wherein the list comprises at least one item to be purchased;
identifying a subset of items from the list whose redemption values are equal to or less than the changed value of reward points;
accessing a customer preference setting associated with the list, the customer preference setting indicating a redemption preference;
based on the customer preference setting, transmitting a notification to the customer regarding redemption of the available reward points for at least one item in the subset of items; and
in response to an approval indication from the customer, processing a purchase of the at least one item.

16. The non-transitory, tangible computer-readable device of claim 15, wherein for updating the stored data profile of the customer, the operations further comprise:
transmitting an application program interface (API) message over a secure network connection,
wherein the API message is one of a hypertext transfer protocol get request message, simple object access protocol (SOAP) web service get request message, and representation state transfer (REST) web service get request message.

17. The non-transitory, tangible computer-readable device of claim 15, wherein for identifying a subset of items from the list, the operations further comprise:
determining a purchase cost for each item in the list;
determining a number of reward points equivalent to the purchase cost for each item in the list;
comparing the number of reward points equivalent to the purchase cost for each item in the list with the changed value of reward points available for redemption; and
based on the comparison, selecting at least one item for which the number of reward points equivalent to the purchase cost is equal to or less than the changed value of reward points.

18. The non-transitory, tangible computer-readable device of claim 15, wherein when the approval indication from the customer has previously been received, the operations further comprise:
sending to the customer a notification message regarding the processing of the purchase and a number of reward points redeemed.

19. The non-transitory, tangible computer-readable device of claim 18, wherein for the sending, the operations further comprise:
sending the notification message in an application program interface (API) message over a secure network connection,
wherein the API message is one of a hypertext transfer protocol post message, simple object access protocol (SOAP) web service post request message, and representation state transfer (REST) web service post request message.

20. The non-transitory, tangible computer-readable device of claim 15, wherein the operations further comprise:
consolidating reward points from a plurality of reward accounts of the customer to determine the changed value of reward points available for redemption.
